(19) United States
(12) Patent Application Publication
(10) Pub. No.: US 2011/0116495 A1
(43) Pub. Date: May 19, 2011

(54) METHOD AND APPARATUS FOR INTER-DEVICE SESSION TRANSFER BETWEEN INTERNET PROTOCOL (IP) MULTIMEDIA SUBSYSTEM (IMS) AND H.323 BASED CLIENTS

(75) Inventors: Debashish Purkayastha, Collegeville, PA (US); Kamel M. Shaheen, King of Prussia, PA (US); Robert G. Gazda, Spring City, PA (US)

(73) Assignee: INTERDIGITAL PATENT HOLDINGS, INC., Wilmington, DE (US)

(21) Appl. No.: 12/938,603

(22) Filed: Nov. 3, 2010

Related U.S. Application Data
(60) Provisional application No. 61/257,725, filed on Nov. 3, 2009.
(60) Provisional application No. 61/261,015, filed on Nov. 13, 2009.
(60) Provisional application No. 61/265,594, filed on Dec. 1, 2009.
(60) Provisional application No. 61/265,890, filed on Dec. 2, 2009.

(51) Int. Cl. H04L 12/66

(52) U.S. Cl. 370/352

(57) ABSTRACT

Methods and apparatus for inter-device session transfer between devices operating according to different protocols are disclosed. The session may be a multimedia session supported by. Session Initiation Protocol (SIP) and the H.323 standard. The devices may include a SIP Client or an H.323 Client. The SIP Client may be an IMS-based SIP Client. An InterWorking Function (IWF) may support a session transfer from a SIP Client to an H.323 Client or from an H.323 Client to a SIP Client. A Media Gateway Control Function (MGCF) may support a session transfer from an Internet Protocol (IP) Multimedia Subsystem (IMS)-based SIP Client to an H.323 Client or from an H.323 Client to an IMS-based SIP Client.

### CROSS REFERENCE TO RELATED APPLICATIONS

This application claims the benefit of U.S. Provisional Application Ser. No. 61/257,725 filed on Nov. 3, 2009; U.S. Provisional Application Ser. No. 61/261,015 filed on Nov. 13, 2009; U.S. Provisional Application Ser. No. 61/265,594 filed on Dec. 1, 2009; and U.S. Provisional Application Ser. No. 61/265,890 filed on Dec. 2, 2009, the contents of which are hereby incorporated by reference herein.

### BACKGROUND

The Internet Protocol (IP) Multimedia Subsystem (IMS) is an architectural framework for delivering IP-based multimedia services. A wireless transmit/receive unit (WTRU) may connect to an IMS through various access networks, including but not limited to networks based on technology such as Universal Mobile Telecommunication System (UMTS) Terrestrial Radio Access Network (UTRAN), Long Term Evolution (LTE), Worldwide Interoperability for Microwave Access (WiMax), or Wireless Local Area Network (WLAN) technology. A WTRU may access the IMS through a packet-switched (PS) domain. Through the use of IMS Centralized Services (ICS), a WTRU may additionally access IMS services via a circuit-switched (CS) domain.

Session Initiation Protocol (SIP) is a signaling protocol for initiating, managing, and terminating voice sessions across packet networks. A SIP Session may involve one or more participants, and SIP may support unicast or multicast communication. SIP is highly extensible and may be extended to accommodate various features and services, for example, call control services, presence, instant messages, mobility, and interoperability with existing systems.

The H.323 standard describes a protocol for providing audio-visual communication on a packet network. The H.323 standard addresses call signaling and control, multimedia transport and control, and bandwidth control for point-to-point and multi-point communication. Enterprise networks may contain a H.323-based multimedia communication system that provides multimedia communication services such as, for example, audio, video, or texting services.

Inter device transfer (IDT) allows a communication session to be transferred from one wireless transmit/receive unit (WTRU) to another. In some scenarios, a session transfer may be desired between devices connected to the same network that operate according to different protocols. Accordingly, it would be advantageous to perform inter-protocol inter-device session transfer.

### SUMMARY

Methods and apparatus for inter-device session transfer between devices operating according to different protocols are disclosed. The session may be a multimedia session supported by SIP and the H.323 standard. The devices may include a SIP Client or an H.323 Client. The SIP Client may be an IMS-based SIP Client. An InterWorking Function (IWF) may support a session transfer from a SIP Client to an H.323 Client or from an H.323 Client to a SIP Client. The IWF may translate a message received via SIP signaling to an H.323 signaling protocol. The IWF may also translate a message received via an H.323 signaling protocol to SIP signaling. A Media Gateway Control Function (MGCF) may facilitate communication between an IMS-based SIP Client and an H.323 Client and may support a session transfer from an IMS-based SIP Client to an H.323 Client or from an H.323 Client to an IMS-based SIP Client. The MGCF may translate a message received via SIP signaling to an H.323 signaling protocol. The MGCF may also translate a message received via an H.323 signaling protocol to SIP signaling.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 2 is a diagram of an example of an Internet Protocol multimedia core network;

FIG. 3A shows a call flow for a basic call establishment between a SIP User Agent and an H.323 Endpoint where the source is the H.323 Endpoint and the destination is the SIP User Agent;

FIG. 3B shows a call flow for a basic call establishment between a SIP User Agent and an H.323 Endpoint where the source is the SIP User Agent and the destination is the H.323 Endpoint;

FIG. 4A shows the IWF located in the service provider Softswitch;

FIG. 4B shows the IWF located at the edge of a service provider network;

FIG. 4C shows the IWF located at the edge of an Enterprise Network;

FIG. 5 shows an overview of an interaction between 3GPP and H.323 networks;

FIG. 6 shows an example of source device-initiated session transfer between a SIP Client and an H.323 Client whereby the SIP Client is the source device;

FIG. 7 shows an example of source device-initiated session transfer between an H.323 Client and a SIP Client whereby the H.323 Client is the source device;

FIG. 8 shows an example of target-initiated session transfer between an H.323 Client and a SIP Client whereby the H.323 Client is the target device;

FIG. 9 shows an example of target-initiated session transfer between an H.323 Client and a SIP Client whereby the SIP Client is the target device;

FIG. 10 shows an example of source device-initiated session transfer between an IMS Client and an H.323 Client whereby the IMS Client is the source device;

FIG. 11 shows an example of source device-initiated session transfer between an IMS Client and an H.323 Client whereby the H.323 Client is the source device;

FIG. 12 shows an example of target-initiated session transfer between an IMS Client and an H.323 Client whereby the H.323 Client is the target device; and

FIG. 13 shows an example of target-initiated session transfer between an IMS Client and an H.323 Client whereby the IMS Client is the target device.

### DETAILED DESCRIPTION

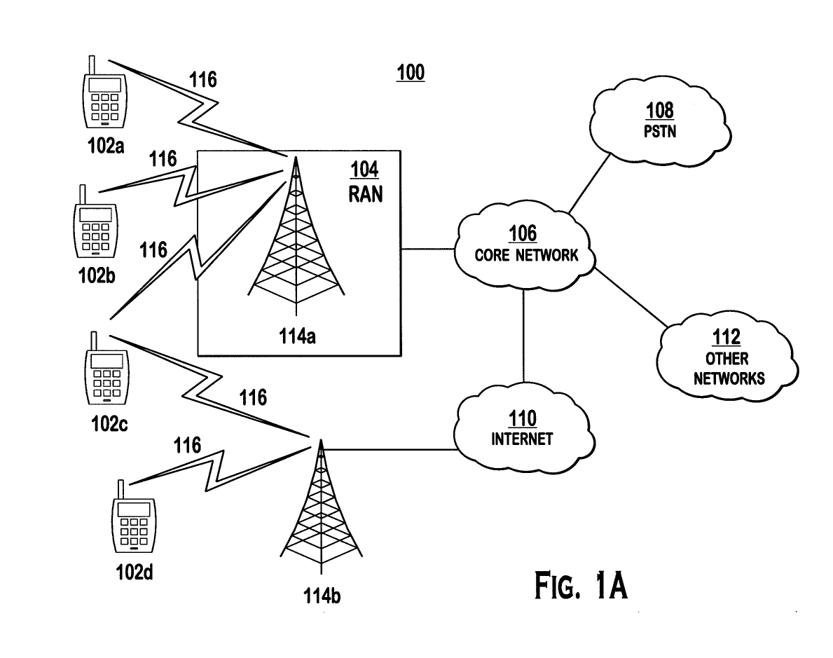

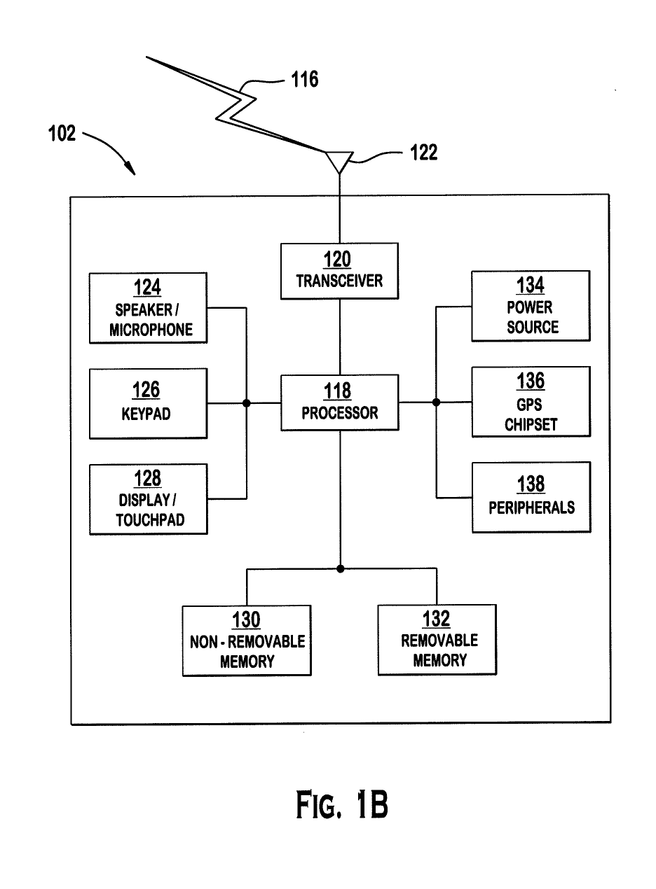

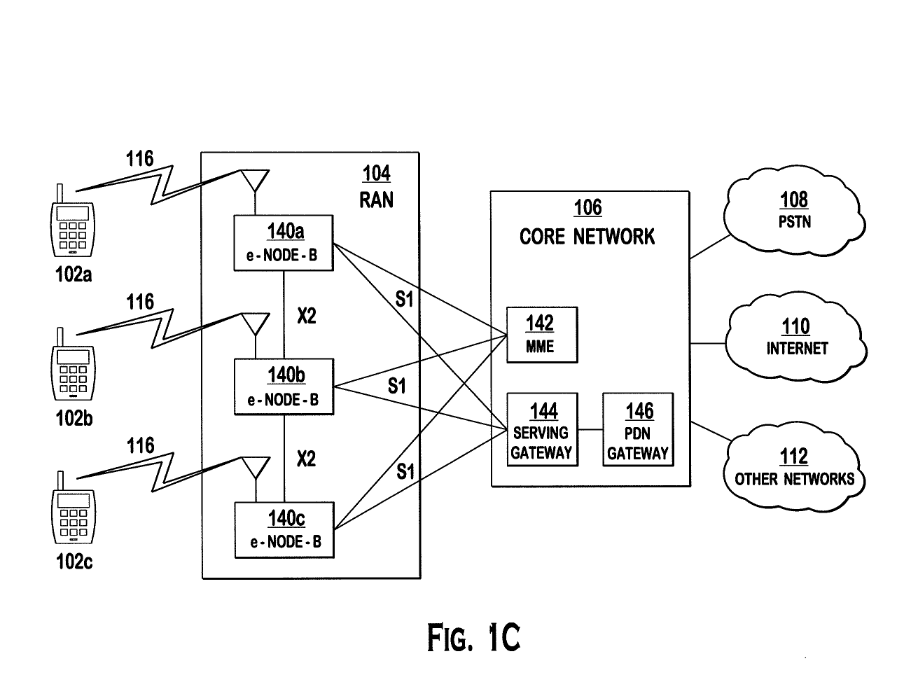

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 106, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 106 and/or the removable memory 132. The non-removable memory 106 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 142a, 142b, 142c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

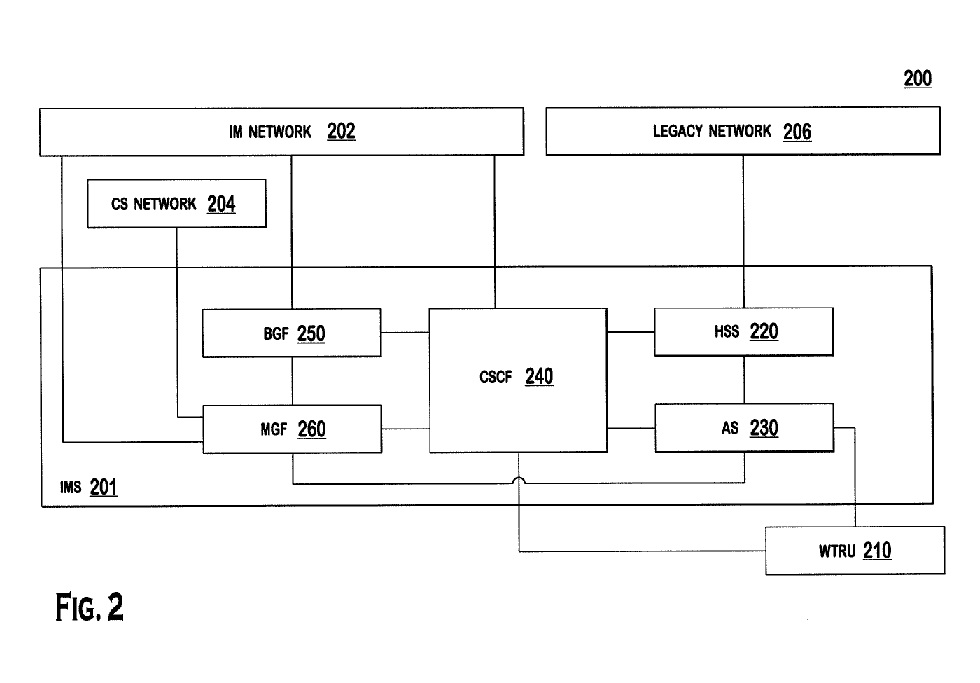

FIG. 2 is a diagram of an example of a Internet Protocol (IP) multimedia core network (IM CN) 200, including an IP Multimedia (IM) Subsystem (IMS) 201, an IM network 202, a Circuit Switched (CS) network 204, a legacy network 206, in communication with a wireless transmit/receive unit (WTRU) 210. The IMS 200 includes core network (CN) elements for provision of IM services, such as audio, video, text, chat, or a combination thereof, delivered over the packet switched domain. As shown, the IMS 201 includes a Home Subscriber Server (HSS) 220, an Application Server (AS) 230, a Call Session Control Function (CSCF) 240, a Breakout Gateway Function (BGF) 250, a Media Gateway Function (MGF) 260, and a Service Centralization and Continuity Application Server (SCC AS) 270. In addition to the logical entities and signal paths shown in FIG. 2, an IMS may include any other configuration of logical entities which may be located in one or more physical devices. Although not shown in this logical example, the WTRU may be a separate physical unit and may be connected to the IM CN via a base station such as, a Node-B or an enhanced-NodeB (eNB).

The WTRU 210 may be any type of device configured to operate and/or communicate in a wired and/or wireless environment.

The HSS 220 may maintain and provide subscription-related information to support the network entities handling IM sessions. For example, the HSS may include identification information, security information, location information, and profile information for IMS users.

The AS 230, which may be a SIP Application Server, an OSA Application Server, or a CAMEL IM-SSF, may provide value added IM services and may reside in a home network or in a third party location. The AS may be included in a network, such as a home network, a core network, or a standalone AS network. The AS may provide IM services. For example, the AS may perform the functions of a terminating user agent (UA), a redirect server, an originating UA, a SIP proxy, or a third party call control.

The CSCF 240 may include a Proxy CSCF (P-CSCF), a Serving CSCF (S-CSCF), an Emergency CSCF (E-CSCF), or an Interrogating CSCF (I-CSCF). For example, a P-CSCF may provide a first contact point for the WTRU within the IMS, a S-CSCF may handle session states, and a I-CSCF may provide a contact point within an operator's network for IMS connections destined to a subscriber of that network operator, or to a roaming subscriber currently located within that network operator's service area.

The BGF 250 may include an Interconnection Border Control Function (IBCF), a Breakout Gateway Control Function (BGCF), or a Transition Gateway (TrGW). Although described as a part of the BGF, the IBCF, the BGCF, or the TrGW may each represent a distinct logical entity and may be located in one or more physical entities.

The IBCF may provide application specific functions at the SIP/SDP protocol layer to perform interconnection between operator domains. For example, the IBCF may enable communication between SIP applications, network topology hiding, controlling transport plane functions, screening of SIP signaling information, selecting the appropriate signaling interconnect, and generation of charging data records.

The BGCF may determine routing of IMS messages, such as SIP messages. This determination may be based on information received in the signaling protocol, administrative information, or database access. For example, for PSTN/CS Domain terminations, the BGCF may determine the network in which PSTN/CS Domain breakout is to occur and may select a MGCF.

The TrGW, may be located on the media path, may be controlled by an IBCF, and may provide network address and port translation, and protocol translation.

The MGF 260 may include a Media Gateway Control Function (MGCF), a Multimedia Resource Function Controller (MRFC), a Multimedia Resource Function Processor (MRFP), an IP Multimedia Subsystem—Media Gateway Function (IMS-MGW), or a Media Resource Broker (MRB). Although described as a part of the MGF, the MGCF, the MRFC, the MRFP, the IMS MGW, or the MRB may each represent a distinct logical entity and may be located in one or more physical entities.

The MGCF may control call state connection control for media channels in IMS; may communicate with CSCF, BGCF, and circuit switched network entities; may determine routing for incoming calls from legacy networks; may perform protocol conversion between ISUP/TCAP and the IM subsystem call control protocols; and may forward out of band information received in MGCF to CSCF/IMS-MGW.

The MRFC and MRFP may control media stream resources. The MRFC and MRFP may mix incoming media streams; may source media streams, for example for multimedia announcements; may process media streams, such as by performing audio transcoding, or media analysis; and may provide floor control, such as by managing access rights to shared resources, for example, in a conferencing environment.

The IMS-MGW may terminate bearer channels from a switched circuit network and media streams from a packet network, such as RTP streams in an IP network. The IMS-MGW may support media conversion, bearer control and payload processing, such as, codec, echo canceller, or conference bridge. The IMS-MGW may interact with the MGCF for resource control; manage resources, such an echo canceller; may include a codec. The IMS-MGW may include resources for supporting UMTS/GSM transport media.

The MRB may support the sharing of a pool of heterogeneous MRF resources by multiple heterogeneous applications. The MRB may assign, or releases, specific MRF resources to a call as requested by a consuming application, based on, for example, a specified MRF attribute. For example, when assigning MRF resources to an application, the MRB may evaluate the specific characteristics of the media resources required for the call or calls; the identity of the application; rules for allocating MRF resources across different applications; per-application or per-subscriber SLA or QoS criteria; or capacity models of particular MRF resources.

The SCC AS 270 may provide communication session service continuity, such as duplication, transfer, addition, or deletion of communication sessions, among multiple WTRUs, for example, in a subscription. The SCC AS may perform Access Transfer, Session Transfer or Duplication, Terminating Access Domain Selection (T-ADS), and Handling of multiple media flows. The SCC AS may combine or split media flows over one or more Access Networks. For example, a media flow may be split or combined for Session Transfers, session termination, upon request by the WTRU to add media flows over an additional Access Network during the setup of a session, or upon request by the WTRU to add or delete media flows over one or more Access Networks to an existing session.

A communication session may be performed using a communication system, such as the communication system shown in FIG. 1A, between a WTRU, such as the WTRU shown in FIG. 1B, and a remote device. The WTRU may access the communication system via a RAN, such as the RAN shown in FIG. 1C, or any other wired or wireless access network. The communication session may include services, such as IP multimedia (IM) services provided by the IMS as shown in FIG. 2.

The WTRU, the remote device, or the network may control the communication session. Control of the communication session may include, for example, starting or stopping a media flow, adding or removing a media flow, transferring or duplicating a media flow on another WTRU, adjusting a bit-rate, or terminating the communication. A WTRU may initiate a communication session with a remote device. The WTRU may initially control the communication session, but may pass or share control of the communication session with the remote device.

In many cases, it may be useful to perform efficient session transfer between devices that operate according to different protocols. As an example, a user device may have an established media session, for example, a video conference. The device may be operating, for example, according to a SIP protocol. If the user enters a conference room or any other area, the user may desire to transfer the video conference to a device in the conference room. The device in the conference room may, for example, be operating according to an H.323 standard. Thus, the user may desire to transfer some or all of a SIP device's active sessions to the H.323 device. Therefore, it may be advantageous to support an inter-protocol, inter-device session transfer between a SIP device and an H.323 device.

Various network elements of an H.323 system may be used during a session transfer. Terminals are examples of network elements and may be devices that include a signaling end point supporting one or more users. An H.323 call model may be executed, for example, between two terminals, between a terminal and a Gatekeeper, and/or between a terminal and a gateway. Gatekeepers may be the brain of an H.323 zone. An H.323 zone may include terminals, gateways, and/or WTRUs managed by, for example, a Gatekeeper. Managing an H.323 WTRU may include registration, access control, and status (RAS). H.323 devices may perform various types of communications and gateways may offer access to a variety of segments.

An H.323 call model may have several variations. For example, an H.323 call model may be a directly routed model and/or a Gatekeeper-routed model. An H.323 call model may include call setup, initial communication between endpoints and terminals, establishment of audio and/or visual communication between endpoints, request and negotiation of call services, and call termination.

H.323 may include the use of other subprotocols. For example, H.225.0 may be used for connection setup and media transport (RTP). H.245 may be used for call control and capability negotiation, and H.235 may be used for security. A variety of H.323 functions may be used during a session transfer. For example, one function may include registration with a Gatekeeper with a RAS protocol using H.225.0 (over user datagram protocol (UDP)). Another function may include signaling using H.225.0 (over transfer control protocol (TCP)). Another function may include logical channel capability negotiation, for example, media control, using H.245 (over TCP).

An InterWorking Function (IWF) may support a session transfer between a SIP Client and an H.323 Client. The IWF may serve as an intermediary, a mediator, an anchor, and/or a translator between SIP and H.323 protocols. The functionality of the IWF may include user registration, address translation, establishment of call connect, and/or service provision. The IWF functionality may be implemented as part of a VoIP network server such as an H.323 Gatekeeper, a SIP Proxy, and/or a Softswitch, which might include a Gatekeeper and SIP Proxy. The functionality may also be implemented via an external SIP-H.323 signaling gateway. The IWF may support communication with a SIP Server and may receive SIP requests from the SIP Server. The SIP request may originate from a SIP device. The IWF may process the SIP requests and translate the requests to an appropriate request and/or message corresponding to the H.323 protocol. Similarly, the IWF may communicate with an H.323 Gateway to receive H.323 requests that may originate from an H.323 device. The IWF may process the H.323 requests and translate the requests to an appropriate request and/or message corresponding to a SIP protocol.

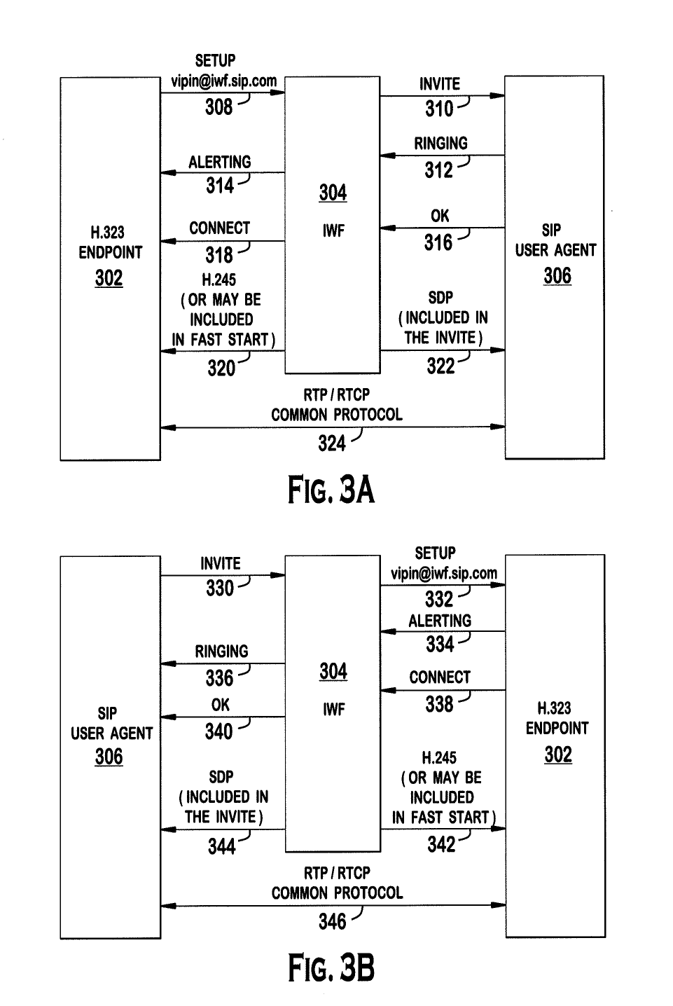

The IWF may support basic call establishment between a SIP User Agent and an H.323 Endpoint. The IWF may support call establishment where the H.323 Endpoint is the source and the SIP User Agent is the destination. The IWF may also support call establishment where the SIP User Agent is the source and the H.323 Endpoint is the destination. FIGS. 3A and 3B show call flows for IWF support of call establishment when either the H.323 Endpoint or the SIP User Agent are the source.

FIG. 3A shows a call flow for a basic call establishment between a SIP User Agent and an H.323 Endpoint where the source is the H.323 Endpoint and the destination is the SIP User Agent. In this scenario, the H.323 Endpoint 302 communicates with the IWF 304 to establish a call with the SIP User Agent 306. The H.323 Endpoint 302 may send a SETUP message 308 to the IWF 304. The SETUP message 308 may include a SIP address. The IWF 304 may send an INVITE message 310 to the SIP User Agent 306. In response, the SIP User Agent 306 may send a Ringing message 312 to the IWF 304. The IWF 304 may send an Alerting message 314 to the H.323 Endpoint 302. The SIP User Agent 306 may send an OK message 316 to the IWF 304. The IWF 304 may send a CONNECT message 318 to the H.323 Endpoint 302. Session setup/negotiation may occur between the H.323 Endpoint 302 and the SIP User Agent 306 with support from the IWF 304. The H.323 Endpoint 302 may use H.245 320 for session setup. The SIP User Agent 306 may use Session Description Protocol (SDP) 322 for session setup. The negotiation may occur via SIP messages containing SDP and/or via a standalone SDP message exchange. The IWF 304 may act as a translator during the session setup/negotiation phase. The H.323 Endpoint 302 and the SIP User Agent 306 may communicate via an RTP/RTCP common protocol 324.

H.245 may handle end-to-end control messages between H.323 entities. H.245 procedures may establish logical channels for transmission of audio, video, data, and control channel information. The exchange of capabilities, the opening and closing of logical channels, preference modes, and message control may occur over a control channel. H.245 control may also enable separate transmit and receive capability exchanges as well as function negotiation, such as determining which codec to use, which necessary parameters to open, and when to begin media transmission.

Alternatively or in addition to using H.245, and to potentially reduce the number of signaling exchanges, the FAST CONNECT option in H.225 may be used. The “faststart” portion may include logical channel sequences, media channel capabilities, and the parameters necessary to open and begin media transmission. In response, the called endpoint may return an H.225 message (for example, call proceeding, progress, alerting, and/or connect) containing a “faststart” element that selects the accepted terminal capabilities.

Similarly, SIP-based devices may use SDP for session description. SDP may be used for session announcement, session invitation, and parameter negotiation. SDP may be used between end points for negotiation of media type, format, and any associated properties. The session information may have been sent as part of the INVITE message.

FIG. 3B shows a call flow for a basic call establishment between a SIP User Agent and an H.323 Endpoint where the source is the SIP User Agent and the destination is the H.323 Endpoint. In this scenario, the SIP User Agent 306 communicates with the IWF 304 to establish a call with the H.323 Endpoint 302.

The SIP User Agent 306 may send an INVITE message 330 to the IWF 304. In response, the IWF 304 may send a SETUP message 332 to the H.323 Endpoint 302. The SETUP message 332 may include a SIP address. The H.323 Endpoint 302 may send an Alerting message 334 to the IWF 304. The IWF 304 may send a Ringing message 336 to the SIP User Agent 306. The H.323 Endpoint 302 may send a CONNECT message 338 to the IWF 304. The IWF 304 may send an OK message 340 to the SIP User Agent 306. Session setup/negotiation may occur between the H.323 Endpoint 302 and the SIP User Agent 306 with support from the IWF 304. The H.323 Endpoint 302 may use H.245 342 for session setup. The SIP User Agent 306 may use SDP 344 for session setup. The negotiation may occur via SIP messages containing SDP and/or via a standalone SDP message exchange. The IWF 304 may act as a translator during the session setup/negotiation phase. H.245, FAST CONNECT, and/or SDP may be used for session setup/negotiation in the same manner as described above. The H.323 Endpoint 302 and the SIP User Agent 306 may communicate via an RTP/RTCP common protocol 346.

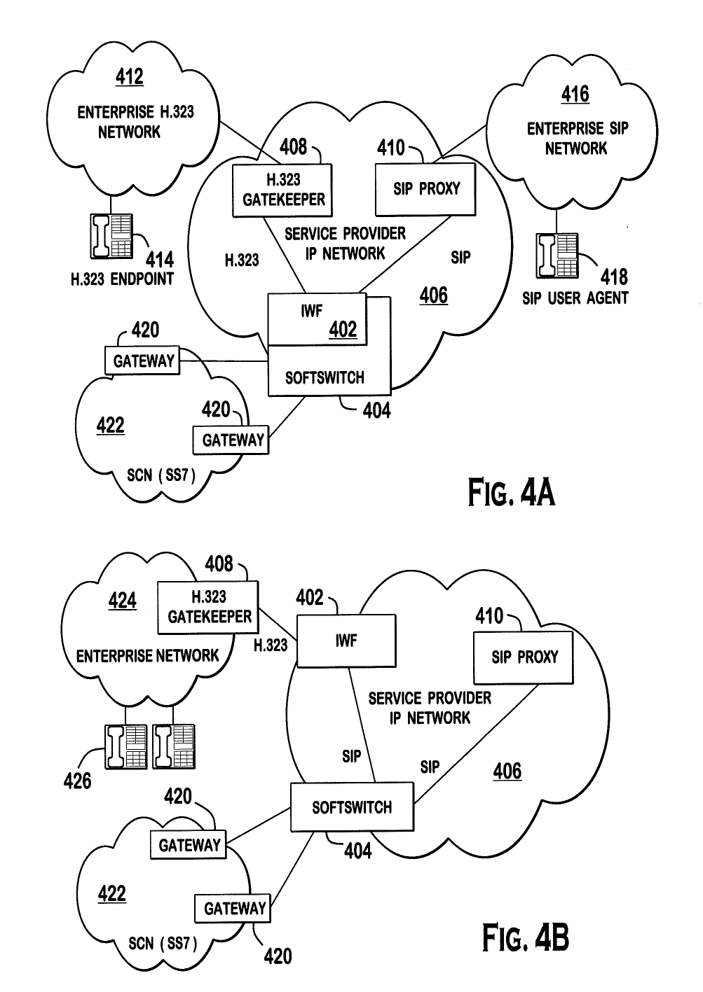

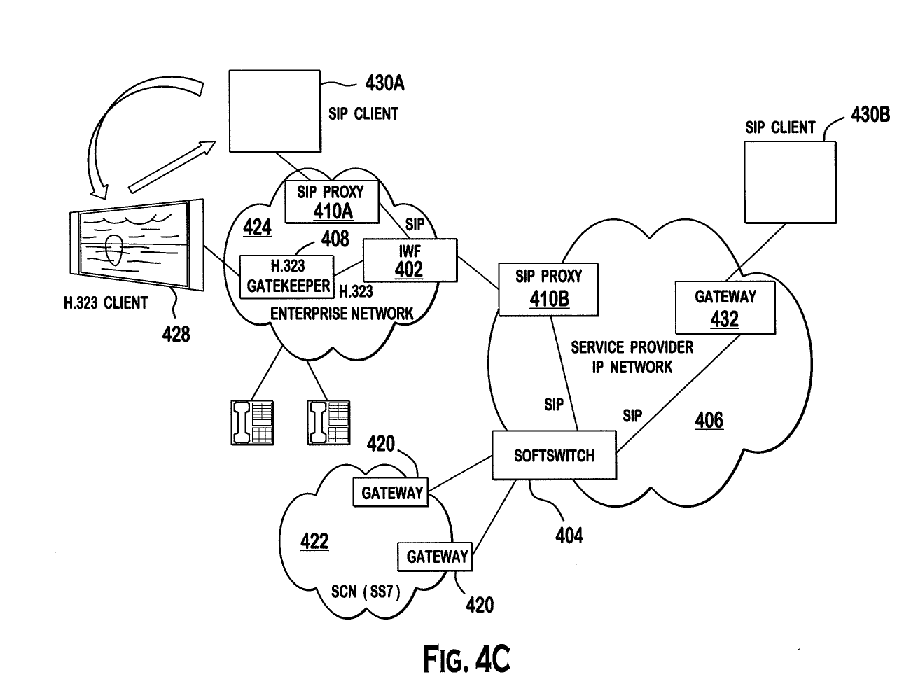

Several network scenarios exist that may support an IWF at various locations in a network. For example, the IWF may be located in the service provider Softswitch, at the edge of the service provider network, and/or at the edge of another network. FIGS. 4A-4C show the IWF located at each of these positions, wherein like numbers represent like elements.

FIG. 4A shows the IWF located in the service provider Softswitch. In this scenario, the IWF 402 may be incorporated in a Softswitch 404 that is located at the edge of the service provider network 406. The IWF 402 may also be located between an H.323 Gatekeeper 408 and a SIP Proxy 410. The H.323 Gatekeeper 408 and the SIP Proxy 410 may also be located in the service provider network 406. The IWF 402 may communicate with the H.323 Gatekeeper 408 that is located in the service provider network 406 via an H.323 protocol. The H.323 Gatekeeper 408 may communicate with an Enterprise H.323 Network 412 that may be located outside of the service provider network 406. The Enterprise H.323 Network 412 may communicate with an H.323 endpoint 414. The IWF 402 may also communicate with the SIP Proxy 410 that is located in the service provider network 406. The SIP Proxy 410 may communicate with an Enterprise SIP Network 416. The Enterprise SIP Network 416 may communicate with any number of SIP devices 418. The IWF 402 may also communicate with Gateways 420 of another network, for example, a Switched Circuit Network (SCN) using Signaling System 7 (SS7) 422.

FIG. 4B shows the IWF located at the edge of the service provider network. In this scenario, the IWF 402 and the Softswitch 404 may be located separately and at the edge of the service provider network 406. The Softswitch 404 may communicate with the IWF 402. The IWF 402 may communicate with the H.323 Gatekeeper 408. The H.323 Gatekeeper 408 may be located in an Enterprise Network 424 and the Enterprise Network 424 may be in contact with any number of users 426. The Softswitch 404 may also communicate with the SIP Proxy 410 and with Gateways 420 of another network, for example, a SCN (SS7) 422.

FIG. 4C shows the IWF located at the edge of the Enterprise Network. In this scenario, the IWF 402 is located at the edge of the Enterprise Network 424, and may communicate with a SIP Proxy 10A and an H.323 Gatekeeper 408, which also may be located in the Enterprise Network 424. Users connecting to the Enterprise Network 424 may include an H.323 Client 428 and/or a SIP Client 430A. The H.323 Client 428 may use H.224 and H.225 protocols. The SIP Client may use SIP protocols and may be IMS-based. The IWF 402 may also communicate with a SIP Proxy 10B that is located at the edge of the service provider network 406. The SIP Proxy 10B may communicate with the Softswitch 404, which may be located at the edge of the service provider network 406. The Softswitch 404 may communicate with a Gateway 32 located in the service provider network and/or with Gateways 20 of another network, for example, a SCN (SS7) 422. The Gateway 32 located in the service provider network may communicate with a SIP Client 30B.

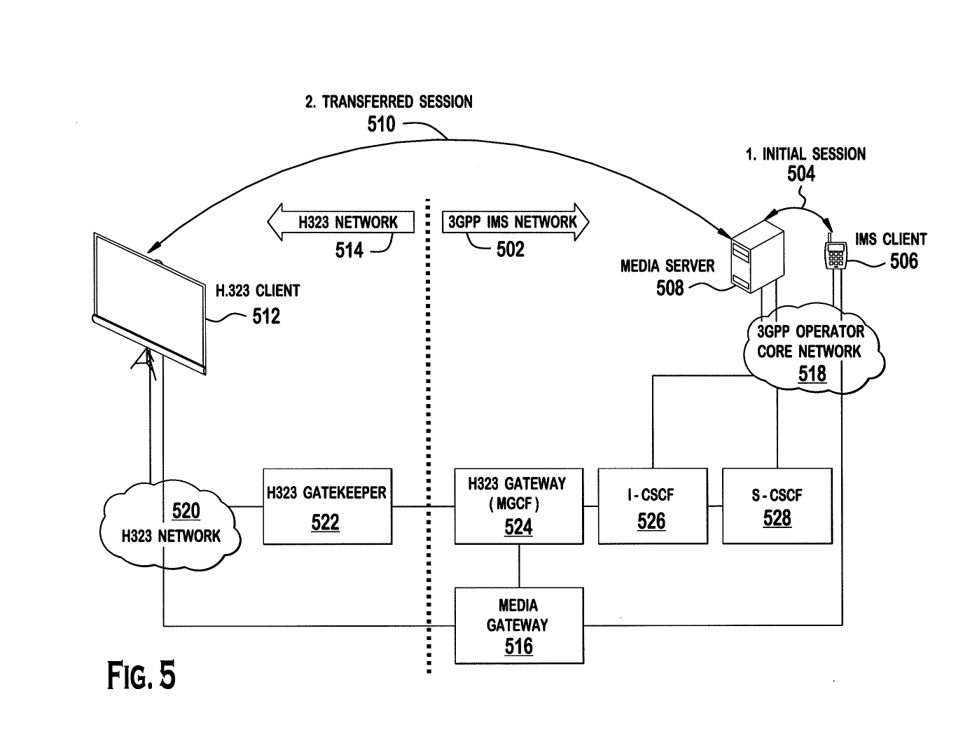

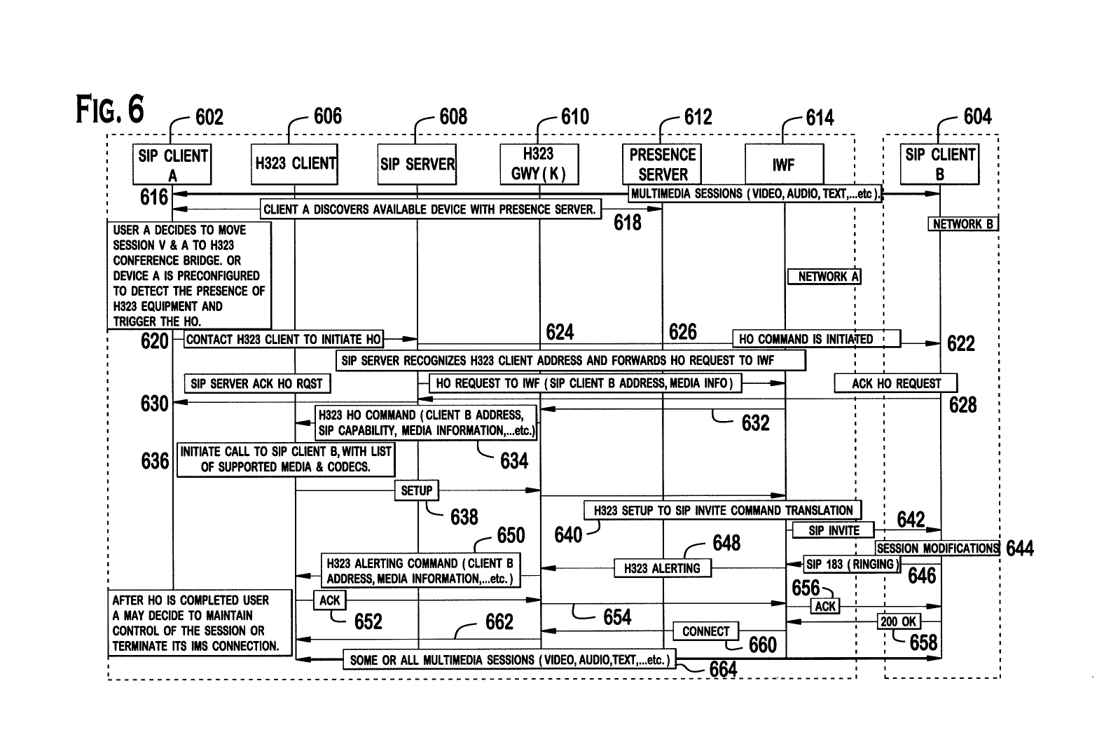

FIG. 5 shows an overview of an interaction between 3GPP and H.323 networks. In a 3GPP IMS network 502, an initial media session 504 may exist between an IMS Client 506 and a Media Server 508. A transferred session 510 may be desired between the Media Server 508 and an H.323 Client 512 located in an H.323 network 514. The H.323 Client 512 may establish a media connection with the IMS Client 506 through a Media Gateway 516 located in the 3GPP IMS network 502. This connection may occur via a 3GPP operator core network 518.

The H.323 Client 512 may also communicate via signaling with the H.323 network 520. The H.323 network 520 may send a signal to an H.323 Gatekeeper 522 located in the H.323 network 514. The H.323 Gatekeeper 522 may send a signal to an H.323 Gateway Media Gateway Control Function (MGCF) 524 located in the 3GPP IMS network 502. The MGCF 524 may communicate with an Interrogatory Call Session Control Function (I-CSCF) 526 and the Media Gateway 516 via signaling. The Media Gateway 516 may communicate with the IMS Client 506. The I-CSCF 526 may communicate directly with the 3GPP operator core network 518 via signaling. The I-CSCF 526 may also communicate indirectly by communicating with a Serving Call Session Control Function (S-CSCF) 528 via signaling. Then, the S-CSCF 528 may communicate with the 3GPP operator core network 518 via signaling. The 3GPP operator core network 518 may communicate with both the Media Server 508 and the IMS Client 506 via signaling. The 3GPP operator core network 518 may also establish media connections with both the Media Server 508 and the IMS Client 506.

The call flow for several examples of session transfer will now be described with reference to the overview and architecture described above. A source device-initiated session transfer occurs if a device that has a media session established initiates the session transfer to another device. A target-initiated session transfer occurs if a device that desires to receive an already established media session initiates the session transfer to itself. In the following examples, a session may be transferred between a SIP Client and an H.323 Client. In some examples, the SIP Client is an IMS-based SIP Client.

A session transfer may be performed between a SIP Client and an H.323 Client whereby the session transfer is source device-initiated. In one example, the source device may be the SIP Client. The SIP Client (SIP Client A) may currently have a multimedia session established with another SIP Client (SIP Client B). Sip Client A and SIP Client B may be connected to different networks. Upon discovery of an available device with H.323 capabilities, SIP Client A may attempt to transfer the session to an H.323 Client. SIP Client A may be connected to the same network as the H.323 Client. The SIP Client may discover the available device, for example, via a Presence Server. The SIP Client may also be preconfigured to detect the presence of H.323 equipment and may trigger the session transfer upon detection.

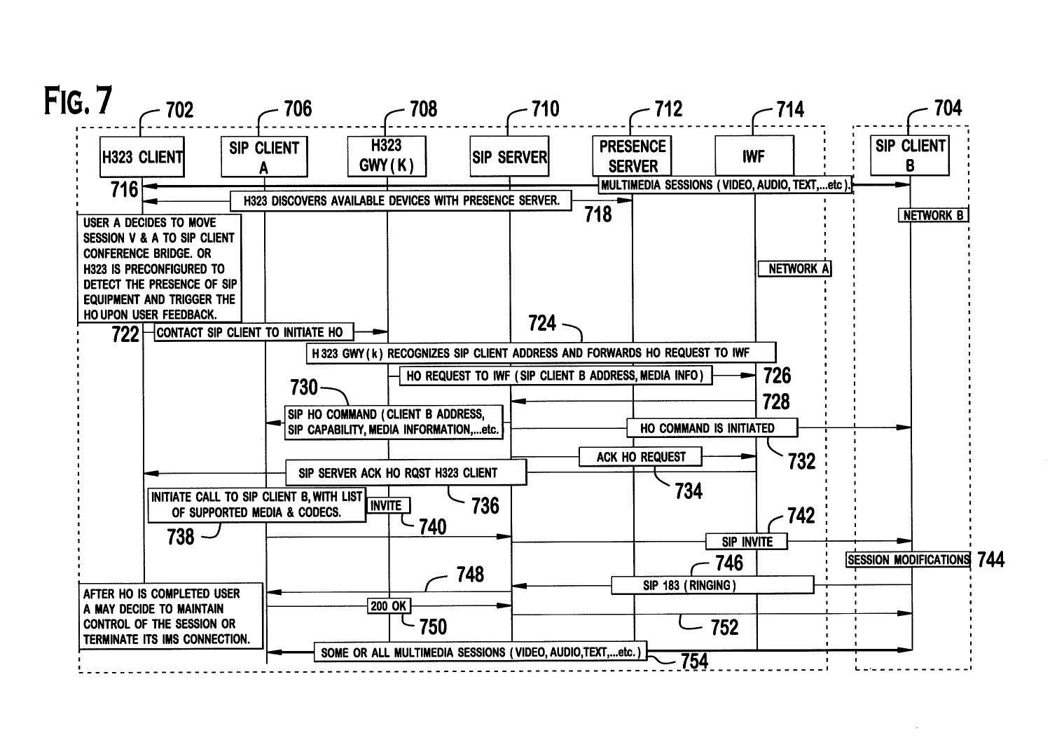

FIG. 6 shows an example of source device-initiated session transfer between a SIP Client and an H.323 Client whereby the SIP Client is the source device. A first SIP Client (SIP Client A) 602 may currently have a multimedia session established with a second SIP Client (SIP Client B) 604. SIP Client A 602 may desire to transfer the multimedia session to an H.323 Client 606. The session transfer may include a SIP Server 608, a H.323 Gateway (H.323 GWY) 610, a Presence Server 612, and an InterWorking Function (IWF) 614.

As described above, SIP Client A 602 may currently have a multimedia session 616 established with SIP Client B 604. SIP Client A 602 may discover the available H.323 device 606 via signaling 618 with the Presence Server 612. Optionally, SIP Client A 602 may be preconfigured to detect the presence of H.323 equipment and may trigger a session transfer upon detection. SIP Client A 602 may signal 620 to the SIP Server 608 to initiate session transfer to the H.323 Client 606. The SIP Server 608 may inform 622 SIP Client B 604 that a session transfer to the H.323 Client 606 has been initiated. The SIP Server 608 may recognize the address 624 of the H.323 Client 606 and may forward a HO Request 626 to the IWF 614. The HO Request 626 may include, for example, the address of SIP Client B 604 and media information related to the session. SIP Client B 604 may send an ACK HO Request message 628 to the SIP Server 608. The SIP Server 608 may send an ACK HO Request message 630 to SIP Client A 602.

The IWF 614 may send a signal 632 to the H.323 GWY 610 with information, for example, the address of SIP Client B 604 and/or the SIP capability of SIP Client B 604 and other media information related to the session. The H.323 GWY 610 may send a HO Command 634 to the H.323 Client, which may include, for example, the address of SIP Client B 604 or the SIP capability of SIP Client B 604 and other media information related to the session. The H.323 Client 606 may initiate a call 636 to SIP Client B 604, which may include, for example, a list of supported media and codec types. The H.323 Client 606 may send a Setup message 638 to the H.323 GWY 610. The H.323 GWY 610 may forward the Setup message 638 to the IWF 614. The IWF 614 may translate 640 the Setup message 638, which may be an H.323 Setup message, to a SIP Invite message 642 that may be sent to SIP Client B 604. SIP Client B may perform session modifications 644. SIP Client B 604 may send a SIP 183 (Ringing) message 646 to the IWF 614. The IWF 614 may signal H.323 Alerting 648 to the H.323 GWY 610. The H.323 GWY 610 may send an H.323 Alerting Command 650 to the H.323 Client 606. The H.323 Alerting Command 650 may include, for example, the address of SIP Client B 604 and/or other media information related to the session. The H.323 Client 606 may send an ACK message 652 to the H.323 GWY 610 in response. The H.323 GWY 610 may forward 654 the ACK message 652 to the IWF 614. The IWF 614 may send an ACK message 656 to SIP Client B 604. SIP Client B 604 may send a 200 (OK) message 658 to the IWF 614 in response. The IWF 614 may send a Connect message 660 to the H.323 GWY 610. The H.323 GWY 610 may forward 662 the Connect message 660 to the H.323 Client 606. Some or all of the multimedia sessions 664 that were originally established between SIP Client A 602 and SIP Client B 604 are now established between the H.323 Client 606 and SIP Client B 604. SIP Client A 602 may also maintain control of the multimedia session or may terminate its connection.

At any point in the method of FIG. 6, additional actions may be performed between the SIP Clients 602, 604, the H.323 Client 606, the SIP Server 608, the H.323 GWY 610, the Presence Server 612, and/or the IWF 614.

In another example of source device-initiated session transfer, the source device may be an H.323 Client. The H.323 Client may currently have a multimedia session established with a SIP Client (SIP Client B). The H.323 Client and SIP Client B may be connected to different networks. Upon discovery of an available device with SIP capabilities, the H.323 Client may attempt to transfer the session to another SIP Client (SIP Client A). For example, the H.323 Client may be re-establishing a session that previously existed between SIP Client A and SIP Client B. SIP Client A may be connected to the same network as the H.323 Client. The H.323 Client may discover the available device, for example, via a Presence Server. The H.323 Client may also be preconfigured to detect the presence of SIP equipment and may trigger the session transfer upon user feedback.

FIG. 7 shows an example of source device-initiated session transfer between an H.323 Client and a SIP Client whereby the H.323 Client is the source device. The H.323 Client 702 may currently have a multimedia session established with SIP Client B 704. H.323 Client 702 may desire to transfer the multimedia session to SIP Client A 706. The session transfer may include an H.323 GWY 708, a SIP Server 710, a Presence Server 712, and an IWF 714.

As described above, H.323 Client 702 may currently have a multimedia session 716 established with SIP Client B 704. The H.323 Client 702 may discover the available SIP Client A 706 via signaling 718 with the Presence Server 712. Optionally, the H.323 Client 702 may be preconfigured to detect the presence of SIP equipment and may trigger the session transfer upon user feedback. The H.323 Client 722 may attempt to contact 722 SIP Client A 706. The H.323 GWY 708 may recognize 724 the address of SIP Client A 706 and forward the HO Request 726 to the IWF 714. The HO Request 726 may include, for example, the address of SIP Client B 704 and media information related to the session. The IWF 714 may forward 728 the HO Request 726 to the SIP Server 710. The SIP Server 710 may send a SIP HO Command 730 to SIP Client A 706. The SIP Server 710 may signal 732 to SIP Client B 704 indicating that the HO Command 730 is initiated. The SIP Server 710 may send an ACK HO Request to the IWF 714. The IWF 714 may send an ACK HO Request 736 to the H.323 Client 702 via the H.323 GWY 708 that may indicate to the H.323 Client that the HO Request 726 has been accepted and initiated. SIP Client A 706 may attempt to initiate a call 738 to SIP Client B 704, which may include, for example, a list of supported media and codec types. To initiate the call, SIP Client A may send an Invite 740 to the SIP Server 710. The SIP Server 710 may send a SIP Invite 742 to SIP Client B 704. SIP Client B 704 may perform session modifications 744. SIP Client B 704 may send a SIP 183 (Ringing) message 746 to the SIP Server 710. The SIP Server may forward the SIP 183 (Ringing) message 746 to SIP Client A 706. SIP Client A 706 may send a 200 (OK) message 750 to the SIP Server 710 in response. The SIP Server 710 may forward 752 the 200 (OK) message 750 to SIP Client B 704. Some or all of the multimedia sessions 754 that were originally established between H.323 Client 702 and SIP Client B 704 are now established between the SIP Client A 706 and SIP Client B 704. SIP Client A 706 may maintain control of the multimedia session or may terminate its connection.

At any point in the method of FIG. 7, additional actions may be performed between the SIP Clients 704, 706, the H.323 Client 702, the H.323 GWY 708, the SIP Server 710, the Presence Server 712, and/or the IWF 714.

A session transfer may also be performed between a SIP Client and an H.323 Client whereby the session transfer is target-initiated. In one example, the target device may be the H.323 Client. A SIP Client (SIP Client A) may currently have a multimedia session established with a SIP Client (SIP Client B). The H.323 Client and SIP Client A may be connected to the same network. The H.323 Client and SIP Client B may be connected to different networks. Upon discovery of an available SIP device, the H.323 Client may attempt to transfer the session from SIP Client A to itself. Optionally, a user may cause the H.323 Client to recognize the SIP Client (SIP Client A) if a user wishes to transfer a media session between the two. The H.323 Client may discover the available device, for example, via a Presence Server. The H.323 Client may also be preconfigured to detect the presence of SIP equipment and may trigger the session transfer upon detection.

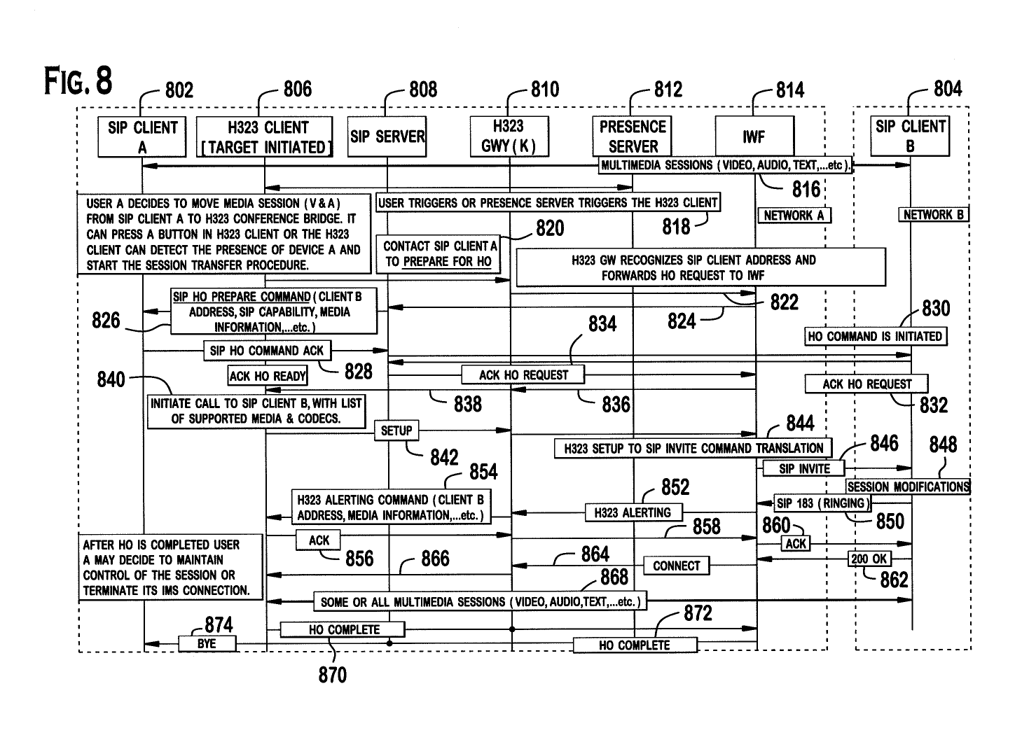

FIG. 8 shows an example of target-initiated session transfer between an H.323 Client and a SIP Client whereby the H.323 Client is the target device. A first SIP Client (SIP Client A) 802 may currently have a multimedia session established with a second SIP Client (SIP Client B) 804. The H.323 Client 806 may desire to transfer the multimedia session from SIP Client A 802 to itself. The session transfer may include a SIP Server 808, a H.323 Gateway (H.323 GWY) 810, a Presence Server 812, and an InterWorking Function (IWF) 814.

As described above, SIP Client A 802 may currently have a multimedia session 816 established with SIP Client B 804. The H.323 Client 806 may be signaled 818 regarding the available SIP device. Optionally, the Presence Server 812 signals the H.323 Client 806. Optionally, the H.323 Client 806 may be preconfigured to detect the presence of SIP equipment and may trigger a session transfer upon detection. Alternatively or additionally, a user may request that the H.323 Client 806 initiates a session transfer procedure. The H.323 Client 806 may attempt to contact SIP Client A 802 with a Prepare for HO message 820. The H.323 GWY 810 may recognize the address of SIP Client A 802 and may forward a HO Request 822 to the IWF 814. The IWF 814 may signal 824 the HO Request 822 to the SIP Server 808. The SIP Server 808 may send a SIP HO Prepare Command 826 to SIP Client A 802. The SIP HO Prepare Command 826 may include, for example, the address of SIP Client B 804 and/or media information related to the session. SIP Client A 802 may send a SIP HO Command ACK 828 to the SIP Server 808. The SIP Server 808 may send a HO Command is Initiated message 830 to SIP Client B 804. SIP Client B 804 may send an ACK HO Request message 832 to the SIP Server 808. The SIP Server 808 may send an ACK HO Request message 834 to the IWF 814. The IWF 814 may signal 836 via the H.323 GWY 810 an ACK HO Ready message 838 to the H.323 Client 806. The H.323 Client 806 may attempt to initiate a call 840 to SIP Client B 804. The call 840 may include, for example, a list of supported media and/or codec types.

The H.323 Client 806 may send a Setup message 842 to the H.323 GWY 810. The H.323 GWY 810 may forward the Setup message 842 to the IWF 814. The IWF 814 may translate the H.323 Setup message to a SIP Invite command. The IWF 814 may send a SIP Invite command 846 to SIP Client B 804. SIP Client B 804 may perform session modifications 848. SIP Client B 804 may send a SIP 183 (Ringing) message 850 to the IWF 814. The IWF 814 may send an H.323 Alerting command 852 to the H.323 GWY 810. The H.323 GWY 810 may forward 854 the H.323 Alerting command 852 to the H.323 Client 806. The H.323 Alerting command 852 may include, for example, the address of SIP Client B 804 and/or media information related to the session. The H.323 Client 806 may send an ACK message 856 to the H.323 GWY 810. The H.323 GWY 810 may forward 858 the ACK message 856 to the IWF 814. The IWF 814 may send an ACK message 860 to SIP Client B 804. SIP Client B 804 may send a 200 OK message to the IWF 814 in response. The IWF 814 may send a Connect message 864 to the H.323 GWY 810. The H.323 GWY 810 may forward 866 the Connect message 864 to the H.323 Client 806. Some or all of the multimedia sessions 868 that were originally established between SIP Client A 802 and SIP Client B 804 may now be established between the H.323 Client 806 and SIP Client B 804. The H.323 Client 806 may send a HO Complete message 870 to the IWF 814 via the H.323 GWY 810. The IWF 814 may send a HO Complete message 872 to SIP Client A 802 via the SIP Server 808. The SIP Server 808 may indicate a BYE message 874 to SIP Client A 802. SIP Client A 802 may also maintain control of the multimedia session or may terminate its connection.

At any point in the method of FIG. 8, additional actions may be performed between the SIP Clients 802, 804, the H.323 Client 806, the SIP Server 808, the H.323 GWY 810, the Presence Server 812, and/or the IWF 814.

In another example of target-initiated session transfer, the target device may be a SIP Client. An H.323 Client may currently have a multimedia session established with a SIP Client (SIP Client B). The H.323 Client and SIP Client B may be connected to different networks. Upon discovery of an available H.323 device, s SIP Client (SIP Client A) may attempt to transfer the session from the H.323 Client to itself. Optionally, a user may cause SIP Client A to recognize the H.323 Client if a user wishes to transfer a media session between the two. The H.323 Client and SIP Client A may be connected to the same network. SIP Client A may discover the available H.323 device, for example, via a Presence Server. The SIP Client may also be preconfigured to detect the presence of H.323 equipment and may trigger the session transfer upon detection.

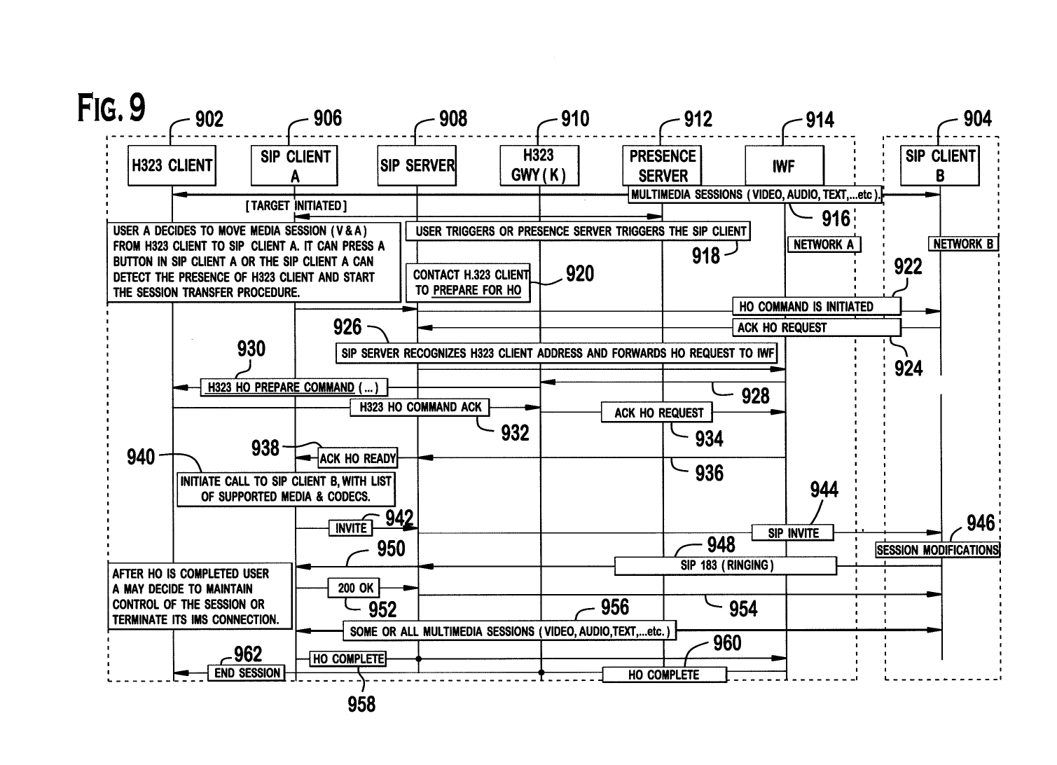

FIG. 9 shows an example of target-initiated session transfer between an H.323 Client and a SIP Client whereby the SIP Client is the target device. The H.323 Client 902 may currently have a multimedia session established with a SIP Client (SIP Client B) 904. Another SIP Client (SIP Client A) 902 may desire to transfer the multimedia session from H.323 Client 902 to itself. The session transfer may include a SIP Server 908, a H.323 Gateway (H.323 GWY) 910, a Presence Server 912, and an InterWorking Function (IWF) 914.

As described above, the H.323 Client 902 may currently have a multimedia session 916 established with SIP Client B 904. SIP Client A 906 may be signaled 918 regarding the available H.323 device. Optionally, the Presence Server 912 signals SIP Client A 906. Optionally, SIP Client A 906 may be preconfigured to detect the presence of H.323 equipment and may trigger a session transfer upon detection. Alternatively or additionally, a user may request that the SIP Client A 906 initiates a session transfer procedure. The SIP Client A 906 may attempt to contact the H.323 Client 902 with a Prepare for HO message 920. The SIP Server 908 may send a HO Command is Initiated message 922 to SIP Client B 904. Sip Client B 904 may send an ACK HO Request message to the SIP Server 908 in response. The SIP Server 908 may recognize the address of the H.323 Client 902 and may forward the HO Request message 926 to the IWF 914. The IWF 914 may forward 928 the HO Request message 926 to the H.323 GWY 910. The H.323 GWY 910 may send an H.323 HO Prepare Command 930 to the H.323 Client 902. The H.323 Client 902 may send an H.323 HO Command ACK 932 to the H.323 GWY 910 in response. The H.323 GWY 910 may send an ACK HO Request message 934 to the IWF 914. The IWF 914 may forward 936 the ACK HO Request message 934 to the SIP Server 908. The SIP Server 908 may send an ACK HO Ready message 938 to SIP Client A 906. SIP Client A 906 may attempt to initiate a call 940 to SIP Client B 904. The call 940 may include, for example, a list of supported media and codec types.

SIP Client A 906 may send an Invite message 942 to the SIP Server 908. The SIP Server 908 may send a SIP Invite message 944 to SIP Client B 904. SIP Client B 904 may perform session modifications 946. SIP Client B 904 may send a SIP 183 (Ringing) message 948 to the SIP Server 908. The SIP Server 908 may forward 950 the SIP 183 (Ringing) message 948 to SIP Client A 906. SIP Client A 906 may send a 200 OK message 952 to the SIP Server 908 in response. The SIP Server 908 may forward 954 the 200 OK message 952 to SIP Client B 904. Some or all of the multimedia sessions 956 that were originally established between the H.323 Client 902 and SIP Client B 904 may now be established between SIP Client A 906 and SIP Client B 904. SIP Client A 906 may send a HO Complete message 958 to the IWF 914 via the SIP Server 908. The IWF 914 may send a HO Complete message 960 to the H.323 Client 902 via the H.323 GWY 910. The H.323 GWY 910 may send an End Session message 962 to the H.323 Client 902. The H.323 Client 902 may maintain control of the multimedia session or may terminate its connection.

At any point in the method of FIG. 9, additional actions may be performed between the SIP Clients 904, 906, the H.323 Client 902, the SIP Server 908, the H.323 GWY 910, the Presence Server 912, and/or the IWF 914.

Alternatively or additionally, a session may be transferred between an H.323 Client and an IMS-based SIP client. To accomplish the session transfer, an H.323-IMS Gateway MGCF may serve as an intermediary. The MGCF may facilitate communication between an IMS Client and an H.323 Client. The MGCF may also establish a leg of communication with an IMS Client and a leg of communication with an H.323 Client. In this way, the MGCF may establish two legs of communication that may later be combined to enable communication between an H.323 Client and an IMS Client. The MGCF may inform a Media Gateway of the two legs that were established. The Media Gateway may be responsible for connecting the two legs to form one session.

A registration procedure may occur among network elements or devices, for example, during start up, power on, or the like. The registration procedure may allow devices to inform a network gateway and/or controller of the presence and availability of the devices. In the examples described herein, registration may comprise two steps. One step may include H.323 devices registering with an H.323 Gatekeeper. Another step may include IMS registration. H.323 Registration may enable gateways, endpoints, and Multipoint Control Units (MCUs) to join a zone and inform a Gatekeeper of their IP and alias addresses. Registration may occur after the discovery process, but before any call may be attempted. IMS Registration may include an IMS Client sending a REGISTER request to the P-CSCF. The P-CSCF may select or resolve the I-CSCF node address (also referred to as “interrogating”) in the client home IMS. The I-CSCF may be the entry point in a home IMS network and may select an S-CSCF node (also referred to as a “serving node”), which may ask a client to authenticate itself. The S-CSCF may communicate with an HSS, a central database, to retrieve authentication parameters. This may result in sending a second REGISTER request that includes authentication parameters.

A session transfer may be performed between an IMS Client and an H.323 Client whereby the session transfer is source device-initiated. In one example, the source device may be the IMS Client. An initial media session may exist between an IMS Client and a Media Server. The IMS Client may wish to transfer the session to an H.323 Client. The IMS Client may be preconfigured to recognize when an H.323 Client is available. The IMS Client may also be instructed by a user to transfer a session to an H.323 Client.

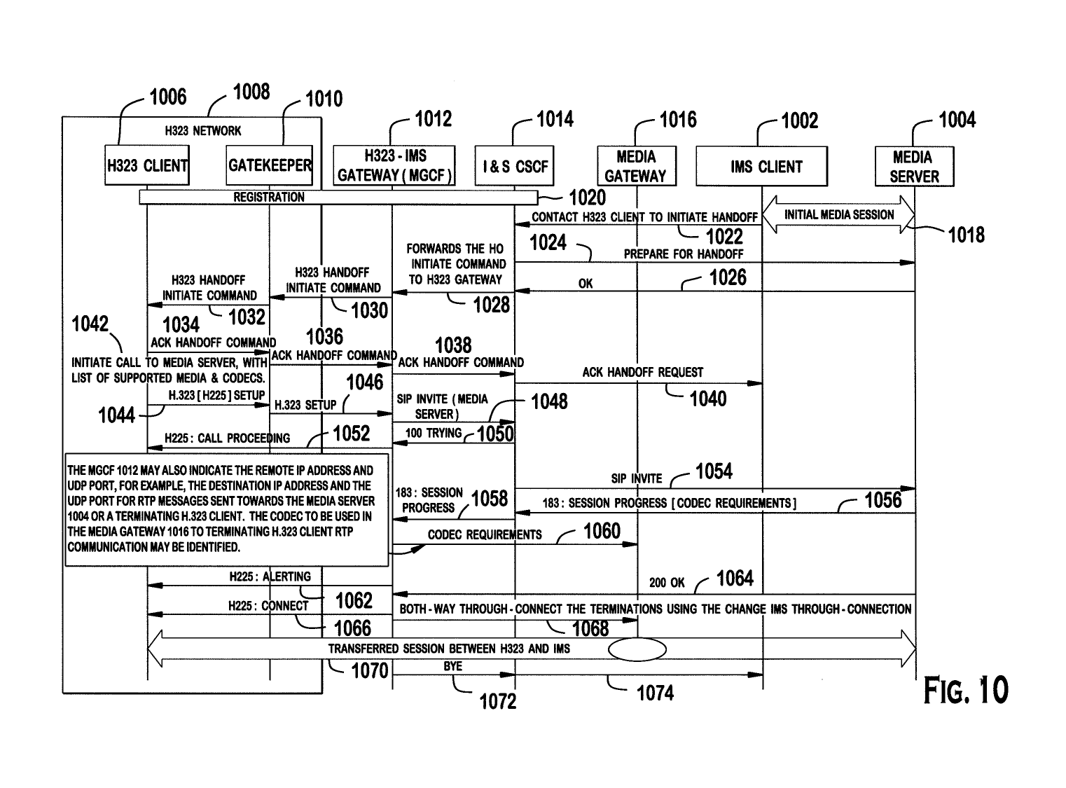

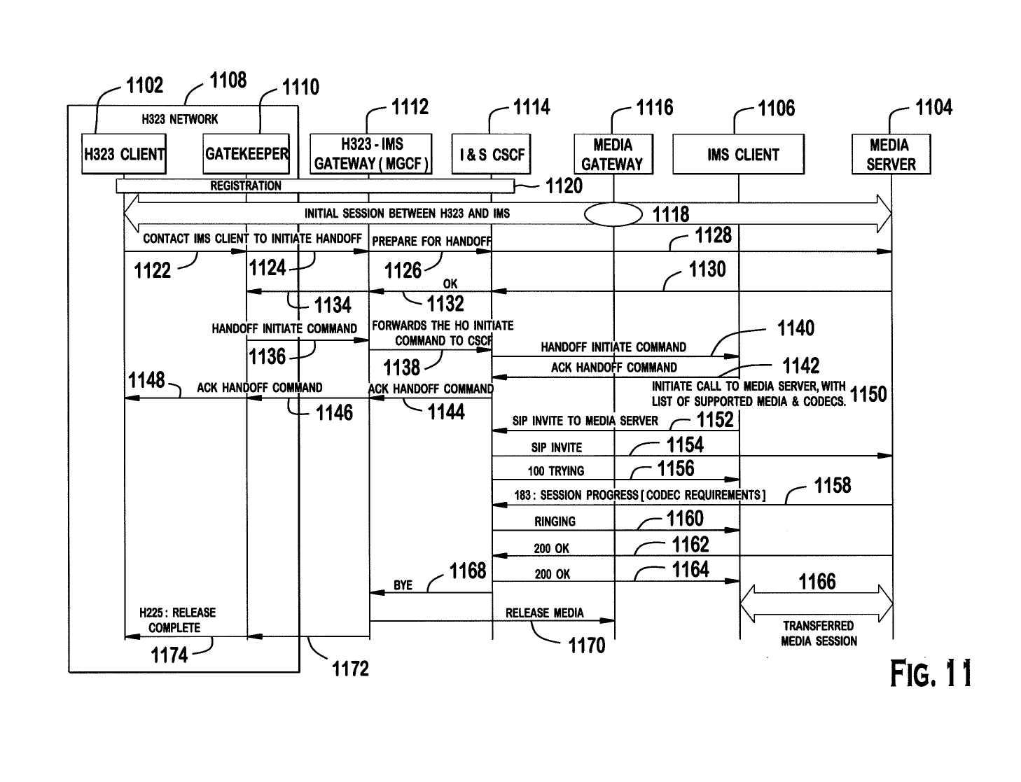

FIG. 10 shows an example of source device-initiated session transfer between an IMS Client and an H.323 Client whereby the IMS Client is the source device. An IMS Client 1002 may already have an initial multimedia session established with a Media Server 1004. The IMS Client 1002 may desire to transfer the multimedia session to an H.323 Client 1006. An H.323 network 1008 may include the H.323 Client 1006 and a Gatekeeper 1010. The session transfer may also include an H.323-IMS Gateway (MGCF) 1012, an I&S CSCF 1014, and a Media Gateway 1016.

As described above, the IMS Client 1002 may currently have an initial multimedia session 1018 established with the Media Server 1004. Registration 1020 of the H.323 Client 1006, the Gatekeeper 1010, the MGCF 1012, and the I&S CSCF 1014 may be required. The IMS Client 1002 may attempt to contact 1022 the H.323 Client 1006 to initiate session transfer. The I&S CSCF 1014 may receive the attempt to contact 1022 the H.323 Client 1006 and may perform registration with the H.323 Client 1006, the Gatekeeper 1010, and the MGCF 1012. The I&S CSCF 1014 may send a Prepare for Handoff message 1024 to the Media Server 1004. The Media Server 1004 may send an OK message 1026 to the I&S CSCF 1014 in response. The I&S CSCF 1014 may forward the earlier HO Initiate Command 1028 to the MGCF 1012. The MGCF 1012 may send an H.323 Handoff Initiate Command 1030 to the Gatekeeper 1010. The Gatekeeper 1010 may send an H.323 Handoff Initiate Command 1032 to the H.323 Client 1006. The H.323 Client 1006 may send an ACK Handoff Command 1034 to the Gatekeeper 1010. The Gatekeeper may forward the ACK Handoff Command 1036 to the MGCF 1012. The MGCF 1012 may send the ACK Handoff Command 1038 to the I&S CSCF 1014. The I&S CSCF 1014 may send an ACK Handoff Request to the IMS Client 1002.

The H.323 Client 1006 may attempt to initiate a call 1042 to the Media Server 1004. The call 1042 may include, for example, a list of supported media and/or codec types. The H.323 Client 1006 may send an H.323 [H.225] Setup message 1044 to the Gatekeeper 1010. The Gatekeeper 1010 may forward the H.323 Setup message 1046 to the MGCF 1012. The MGCF 1012 may send an SIP INVITE [MEDIA SERVER] 1048 to the I&S CSCF 1014 for attempted communication with the Media Server 1004. The I&S CSCF 1014 may send a 100 TRYING message 1050 to the MGCF 1012 in response. The MGCF 1012 may send an H.225: Call Proceeding message 1052 to the H.323 Client 1006. The I&S CSCF 1014 may send a SIP INVITE message 1054 to the Media Server 1004. The Media Server 1004 may send a 183: SESSION PROGRESS [CODEC REQUIREMENTS] message 1056 to the I&S CSCF 1014 in response. The I&S CSCF 1014 may forward the 183: SESSION PROGRESS message 1058 to the MGCF 1012. The MGCF 1012 may send codec requirements 1060 to the Media Gateway 1016. In addition to the codec requirements 1060, the MGCF 1012 may also send, for example, an indication of the remote IP address and UDP port. For example, this may be the destination IP address and the UDP port for RTP messages sent towards the Media Server 1004 and/or a terminating H.323 Client or WTRU. The MGCF 1012 may also identify the codec that is to be used in the Media Gateway 1016 to terminating H.323 Client RTP communication.

The MGCF 1012 may send an H.225: ALERTING message 1062 to the H.323 Client 1006. The Media Server 1004 may send a 200 OK message 1064 to the MGCF 1012. The MGCF 1012 may send an H.225: CONNECT message 1066 to the H.323 Client 1006. The MGCF 1012 may signal 1068 to the Media Gateway 1016 information regarding the two sessions (legs) that the MGCF has established with the H.323 Client 1006 and the Media Server 1004. The Media Gateway 1016 may then connect the two sessions to establish the transferred session 1070 between H.323 and IMS protocols. The MGCF may send a BYE message 1072 to the I&S CSCF 1014. The I&S CSCF 1014 may forward 1074 the BYE message 1072 to the IMS Client 1002. The IMS Client 1002 may maintain the session or may terminate the session.

At any point in the method of FIG. 10, additional actions may be performed between the IMS Client 1002, the Media Server 1004, the H.323 Client 1006, the Gatekeeper 1010, the MGCF 1012, the I&S CSCF 1014, and/or the Media Gateway 1016.

In another example, source device-initiated session transfer may be performed between an IMS Client and an H.323 Client whereby the H.323 Client is the source device. An initial media session may exist between the H.323 Client and a Media Server. The H.323 Client may wish to transfer the session to an IMS Client. The H.323 Client may be preconfigured to recognize when an IMS Client is available. The H.323 Client may also be instructed by a user to transfer a session to an IMS Client.

FIG. 11 shows an example of source device-initiated session transfer between an IMS Client and an H.323 Client whereby the H.323 Client is the source device. An H.323 Client 1102 may already have an initial multimedia session established with a Media Server 1104. The H.323 Client 1102 may desire to transfer the multimedia session to an IMS Client 1106. An H.323 network 1108 may include the H.323 Client 1106 and a Gatekeeper 1110. The session transfer may also include an H.323-IMS Gateway (MGCF) 1112, an I&S CSCF 1114, and a Media Gateway 1116.

As described above, H.323 Client 1102 may currently have an initial multimedia session 1118 established with the Media Server 1104. Registration 1120 of the H.323 Client 1106, the Gatekeeper 1110, the MGCF 1112, and the I&S CSCF 1114 may be required. The H.323 Client 1102 may attempt to contact the Media Server 1104 via the Gatekeeper 1110 to initiate session transfer 1122. The Gatekeeper 1110 may forward an Initiate Handoff message 1124 to the MGCF 1112. The MGCF 1112 may send a Prepare for Handoff message 1126 to the I&S CSCF 1114. The I&S CSCF 1114 may forward the Prepare for Handoff message 1128 to the Media Server 1104. The Media Server 1104 may send an OK message 1130 to the I&S CSCF 1114. The I&S CSCF 1114 may forward the OK message 1132 to the MGCF 1112. The MGCF 1112 may forward the OK message 1134 to the Gatekeeper 1110. The Gatekeeper 1110 may send a Handoff Initiate Command 1136 to the MGCF 1112. The MGCF may forward the Handoff Initiate Command 1138 to the I&S CSCF 1114. The I&S CSCF 1114 may send a Handoff Initiate Command 1140 to the IMS Client 1106. The IMS Client 1106 may send an ACK Handoff Command 1142 to the I&S CSCF 1114 in response. The I&S CSCF 1114 may send an ACK Handoff Command 1144 to the MGCF 1112. The MGCF 1112 may forward the ACK Handoff Command 1146 to the Gatekeeper 1110. The Gatekeeper 1110 may forward the ACK Handoff Command 1148 to the H.323 Client 1102.

The IMS Client 1106 may attempt to initiate a call 1150 to the Media Server 1104. The call 1150 may include, for example, a list of supported media and codec types. The IMS Client 1106 may send a SIP INVITE TO MEDIA SERVER message 1152 to the I&S CSCF 1114. The I&S CSCF 1114 may send a SIP INVITE message 1154 to the Media Server 1104. The I&S CSCF 1114 may send a 100 TRYING message 1156 to the IMS Client 1106. The Media Server 1104 may send a 183: SESSION PROGRESS [CODEC REQUIREMENTS] message 1158 to the I&S CSCF 1114. The I&S CSCF 1114 may send a Ringing message 1160 to the IMS Client 1106. The Media Server 1104 may send a 200 OK message 1162 to the I&S CSCF 1114. The I&S CSCF 1114 may forward the 200 OK message 1164 to the IMS Client 1106. A transferred media session 1166 may now be established between the IMS Client 1106 and the Media Server 1104.

The I&S CSCF 1114 may send a BYE message 1168 to the MGCF 1112. The MGCF 1112 may send a RELEASE MEDIA message 1170 to the Media Gateway 1116. The MGCF 1112 may send an H.225: RELEASE COMPLETE message 1172 to the Gatekeeper 1110. The Gatekeeper 1110 may forward the H.225: RELEASE COMPLETE message 1174 to the H.323 Client 1102. The H.323 Client 1102 may maintain the session or may terminate the session.

At any point in the method of FIG. 11, additional actions may be performed between the H.323 Client 1102, the Media Server 1104, the IMS Client 1106, the Gatekeeper 1110, the MGCF 1112, the I&S CSCF 1114, and/or the Media Gateway 1116.

A session transfer may also be performed between an IMS Client and an H.323 Client whereby the session transfer is target-initiated. In one example, the target device may be the H.323 Client. An initial media session may exist between the IMS Client and a Media Server. The H.323 Client may wish to transfer the session from the IMS Client to itself. The H.323 Client may be preconfigured to recognize when an IMS Client is available. The H.323 Client may also be instructed by a user to transfer a session from an IMS Client.

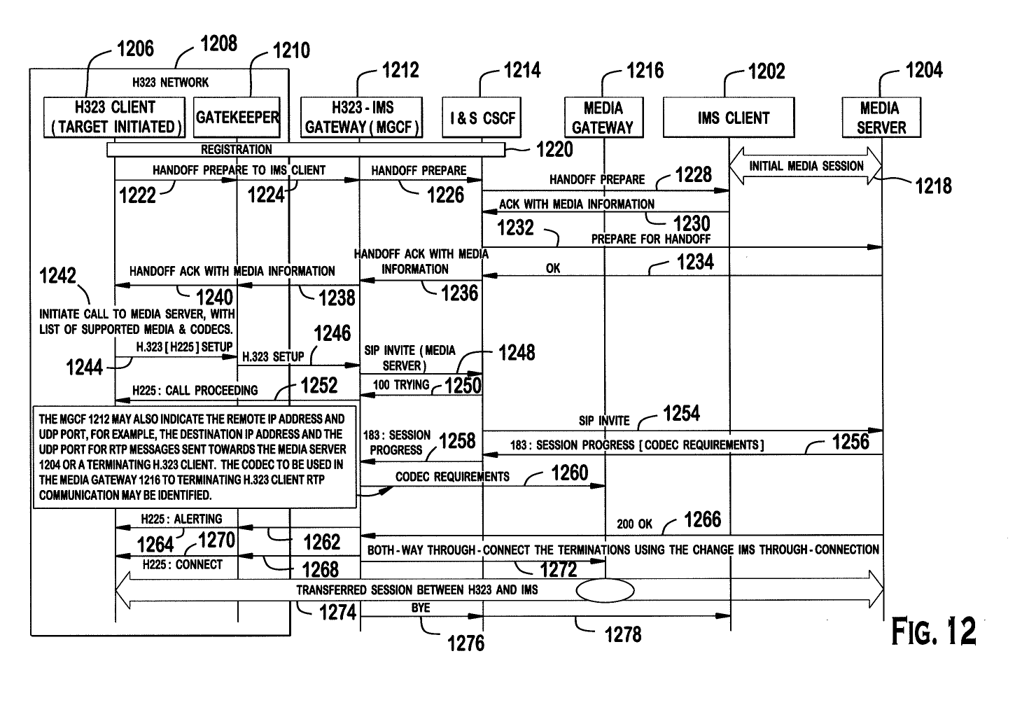

FIG. 12 shows an example of target-initiated session transfer between an IMS Client and an H.323 Client whereby the H.323 Client is the target device. An IMS Client 1202 may already have an initial multimedia session established with a Media Server 1204. The H.323 Client 1206 may desire to transfer the multimedia session to itself. An H.323 network 1208 may include the H.323 Client 1206 and a Gatekeeper 1210. The session transfer may also include an H.323-IMS Gateway (MGCF) 1212, an I&S CSCF 1214, and a Media Gateway 1216.

As described above, IMS Client 1202 may currently have an initial multimedia session 1218 established with the Media Server 1204. Registration 1220 of the H.323 Client 1206, the Gatekeeper 1210, the MGCF 1212, and the I&S CSCF 1214 may be required. The H.323 Client 1206 may attempt to contact 1222 the IMS Client 1202 with a Handoff Prepare message. The Gatekeeper 1210 may forward the Handoff Prepare message 1224 to the MGCF 1212. The MCGF 1212 may send a Handoff Prepare message 1226 to the I&S CSCF 1214. The I&S CSCF 1214 may send a Handoff Prepare message 1228 to the IMS Client 1202. The IMS Client 1202 may send an ACK 1230 that includes media information to the I&S CSCF 1214. The I&S CSCF 1214 may send a Prepare for Handoff message 1232 to the Media Server 1204. The Media Server 1204 may send an OK message 1234 in response. The I&S CSCF 1214 may send a Handoff ACK 1236 that includes media information to the MGCF 1212. The MGCF may forward the Handoff ACK 1238 that includes media information to the Gatekeeper 1210. The Gatekeeper 1210 may forward the Handoff ACK 1240 that includes media information to the H.323 Client 1206.

The H.323 Client 1206 may attempt to initiate a call 1242 to the Media Server 1204. The call 1242 may include, for example, a list of supported media and codec types. The H.323 Client 1206 may send a H.323 [H.225] Setup message 1244 to the Gatekeeper 1210. The Gatekeeper 1210 may forward the H.323 Setup message 1246 to the MGCF 1212. The MGCF 1212 may send a SIP INVITE [MEDIA SERVER] message 1248 to the I&S CSCF 1214. The I&S CSCF 1214 may send a 100 TRYING message 1250 to the MGCF 1212 in response. The MGCF 1212 may send a H.225: Call Proceeding message 1252 to the H.323 Client 1206. The I&S CSCF 1214 may send a SIP INVITE message 1254 to the Media Server 1204. The Media Server 1204 may send a 183: SESSION PROGRESS [CODEC REQUIREMENTS] message 1256 in response. The I&S CSCF 1214 may forward the 183 SESSION PROGRESS message 1258 to the MGCF 1212. The MGCF 1212 may send codec requirements 1260 to the Media Gateway 1216. In addition to the codec requirements 1260, the MGCF 1212 may also send, for example, an indication of the remote IP address and UDP port. For example, this may be the destination IP address and the UDP port for RTP messages sent towards the Media Server 1204 and/or a terminating H.323 Client or WTRU. The MGCF 1212 may also identify the codec that is to be used in the Media Gateway 1216 to terminating H.323 Client RTP communication.

The MGCF 1212 may send an H.225: Alerting message 1262 to the Gatekeeper 1210. The Gatekeeper 1210 may forward the H.225: Alerting message 1264 to the H.323 Client 1206. The Media Server 1204 may send a 200 OK message 1266 to the MGCF 1212. The MGCF 1212 may send an H.225: Connect message 1268 to the Gatekeeper 1210. The Gatekeeper 1210 may forward the H.225: Connect message 1270 to the H.323 Client 1206. The MGCF 1012 may signal 1272 to the Media Gateway 1216 information regarding the two sessions (legs) that the MGCF has established with the H.323 Client 1206 and the Media Server 1204. The Media Gateway 1216 may then connect the two sessions to establish the transferred session 1274 between H.323 and IMS protocols. The MGCF may send a BYE message 1276 to the I&S CSCF 1214. The I&S CSCF 1214 may forward 1278 the BYE message 1276 to the IMS Client 1202. The IMS Client 1202 may maintain the session or may terminate the session.

At any point in the method of FIG. 12, additional actions may be performed between the IMS Client 1202, the Media Server 1204, the H.323 Client 1206, the Gatekeeper 1210, the MGCF 1212, the I&S CSCF 1214, and/or the Media Gateway 1216.

In another example, target-initiated session transfer is performed and an IMS Client is the target. An initial media session may exist between an H.323 Client and a Media Server. The IMS Client may wish to transfer the session from the H.323 Client to itself. The IMS Client may be preconfigured to recognize when an H.323 Client is available. The IMS Client may also be instructed by a user to transfer a session from an H.323 Client.

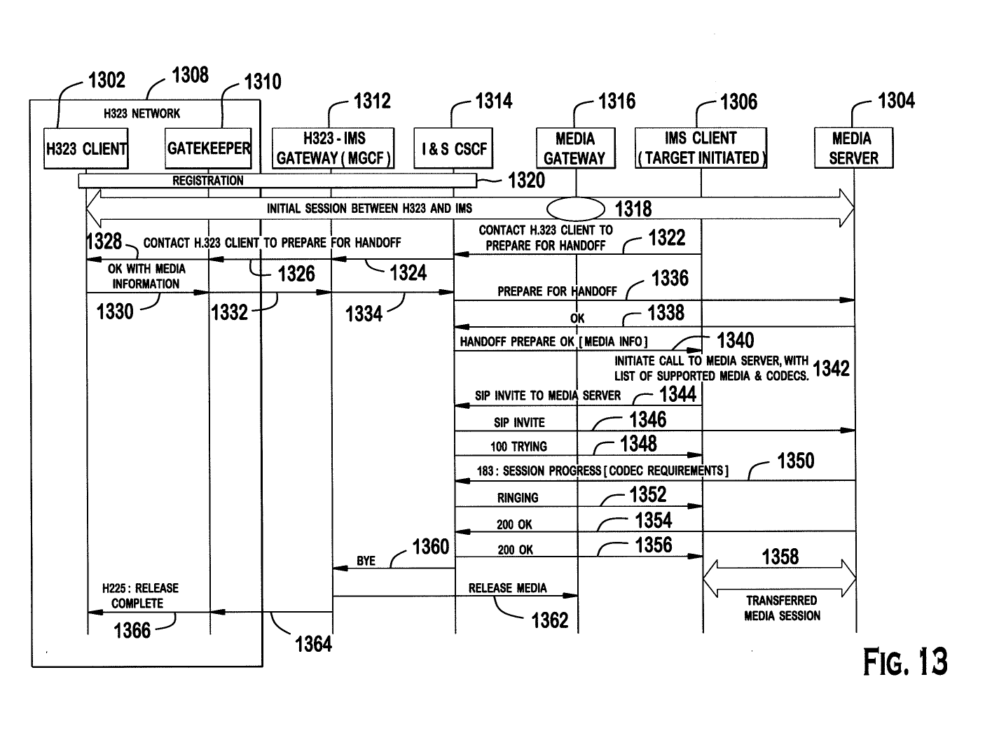

FIG. 13 shows an example of target-initiated session transfer between an IMS Client and an H.323 Client whereby the IMS Client is the target device. An H.323 Client 1302 may already have an initial multimedia session established with a Media Server 1304. The IMS Client 1306 may desire to transfer the multimedia session to itself. An H.323 network 1308 may include the H.323 Client 1302 and a Gatekeeper 1310. The session transfer may also include an H.323-IMS Gateway (MGCF) 1312, an I&S CSCF 1314, and a Media Gateway 1316.

As described above, H.323 Client 1302 may currently have an initial multimedia session 1318 established with the Media Server 1304. Registration 1320 of the H.323 Client 1302, the Gatekeeper 1310, the MGCF 1312, and the I&S CSCF 1314 may be required. The IMS Client 1306 may attempt to contact the H.323 Client 1302 to prepare for transfer 1322. The I&S CSCF 1314 may receive the Prepare for Handoff request and send a Prepare for Handoff message 1324 to the H.323 Client 1302 via the MGCF 1312. The MGCF 1312 may send the Prepare for Handoff message 1326 to the Gatekeeper 1310. The Gatekeeper 1310 may forward the Prepare for Handoff message 1328 to the H.323 Client 1302. The H.323 Client 1302 may send an OK message 1330 that includes media information to the Gatekeeper 1310. The Gatekeeper 1310 may forward the OK message 1332 with media information to the MGCF 1312. The MGCF 1312 may forward the OK message 1334 with media information to the I&S CSCF 1314. The I&S CSCF 1314 may send a Prepare for Handoff message 1336 to the Media Server 1304. The Media Server 1304 may send an OK message 1338 to the I&S CSCF 1314 in response. The I&S CSCF 1314 may send a Handoff Prepare OK [MEDIA INFO] message 1340 to the IMS Client 1306.

The IMS Client 1306 may attempt to initiate a call 1342 to the Media Server 1304. The call 1342 may include, for example, a list of supported media and codec types. The IMS Client 1306 may send a SIP INVITE TO MEDIA SERVER message 1344 to the I&S CSCF 1314. The I&S CSCF 1314 may send a SIP INVITE 1346 to the Media Server 1304. The I&S CSCF 1314 may send a 100 TRYING message 1348 to the IMS Client 1306. The Media Server 1304 may send a 183: SESSION PROGRESS [CODEC REQUIREMENTS] message 1350 to the I&S CSCF 1314. The I&S CSCF 1314 may send a RINGING message 1352 to the IMS Client 1306. The Media Server 1304 may send a 200 OK message 1354 to the I&S CSCF 1314. The I&S CSCF 1314 may forward the 200 OK message 1356 to the IMS Client 1306. A transferred media session 1358 may now be established between the IMS Client 1306 and the Media Server 1304.

The I&S CSCF 1314 may send a BYE message 1360 to the MGCF 1332. The MGCF 1312 may send a RELEASE MEDIA message 1362 to the Media Gateway 1316. The MGCF 1312 may send an H.225: RELEASE COMPLETE message 1172 to the Gatekeeper 1310. The Gatekeeper 1310 may forward the H.225: RELEASE COMPLETE message 1366 to the H.323 Client 1302. The H.323 Client 1302 may maintain the session or may terminate the session.

At any point in the method of FIG. 13, additional actions may be performed between the H.323 Client 1302, the Media Server 1304, the IMS Client 1306, the Gatekeeper 1310, the MGCF 1312, the I&S CSCF 1314, and/or the Media Gateway 1316.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed is:

1. A method for use in an interworking function for session transfer between a Session Initiation Protocol (SIP) device and an H.323 device, the method comprising:
receiving a transfer request message from the SIP device via SIP signaling indicating a request to transfer a multimedia session;
translating the transfer request message to an H.323 signaling protocol; and
transmitting the translated transfer request message to the H.323 device using the H.323 signaling protocol.

2. The method of claim 1, wherein the transfer request message is a SIP invite and the translated transfer request message is an H.323 Setup message.

3. The method of claim 1, wherein the SIP device is an Internet Protocol (IP) Multimedia Subsystem (IMS)-based SIP device.

4. The method of claim 1, further comprising:
receiving a codec request message from a Media Server via SIP signaling indicating a request for codec requirements; and
translating the codec request message to the H.323 signaling protocol; and
transmitting the translated codec request message to the H.323 device using the H.323 signaling protocol.

5. A network element configured to perform interworking functions between a Session Initiation Protocol (SIP) Client and an H.323 Client, comprising:
a receiver configured to receive a transfer request message from the SIP Client via SIP signaling indicating a request to transfer a multimedia session;
a processor configured to translate the transfer request message to an H.323 signaling protocol; and
a transmitter configured to transmit the translated transfer request message to an H.323 Client using the H.323 signaling protocol.

6. The network element of claim 5, wherein the transfer request message is a SIP invite and the translated transfer request message is an H.323 Setup message.

7. The network element of claim 5, wherein the SIP Client is an Internet Protocol (IP) Multimedia Subsystem (IMS)-based SIP Client.

8. The network element of claim 5, further including:
the receiver further configured to receive a codec request message from a Media Server via SIP signaling indicating a request for codec requirements;
the processor further configured to translate the codec request message to the H.323 signaling protocol; and
the transmitter further configured to transmit the translated codec request message to the H.323 Client using the H.323 signaling protocol.

9. A method for use in an interworking function for session transfer between an H.323 device and a Session Initiation Protocol (SIP) device, the method comprising:
receiving a transfer request message from the H.323 device via an H.323 signaling protocol indicating a request to transfer a multimedia session;
translating the transfer request message to a SIP signaling protocol; and
transmitting the translated transfer request message to the SIP device using the SIP signaling protocol.

10. The method of claim 9, wherein the transfer request message is an H.323 Setup message and the translated transfer request message is a SIP invite.

11. The method of claim 9, wherein the SIP device is an Internet Protocol (IP) Multimedia Subsystem (IMS)-based SIP device.

12. The method of claim 9, further comprising:
receiving a codec request message from a Media Server via the H.323 signaling protocol indicating a request for codec requirements; and
translating the codec request message to the SIP signaling protocol; and
transmitting the translated codec request message to the SIP device using the SIP signaling protocol.

13. A network element configured to perform interworking functions between an H.323 Client and a Session Initiation Protocol (SIP) Client, comprising:
a receiver configured to receive a transfer request message from the H.323 Client via an H.323 signaling protocol indicating a request to transfer a multimedia session;
a processor configured to translate the transfer request message to a SIP signaling protocol; and
a transmitter configured to transmit the translated transfer request message to the SIP Client using the SIP signaling protocol.

14. The network element of claim 13, wherein the transfer request message is an H.323 Setup message and the translated transfer request message is a SIP invite.

15. The network element of claim 13, wherein the SIP Client is an Internet Protocol (IP) Multimedia Subsystem (IMS)-based SIP Client.

16. The network element of claim 13, further including:
the receiver further configured to receive a codec request message from a Media Server via the H.323 signaling protocol indicating a request for codec requirements;
the processor further configured to translate the codec request message to the SIP signaling protocol; and
the transmitter further configured to transmit the translated codec request message to the SIP Client using the SIP signaling protocol.
